(19) United States
(12) Patent Application Publication
(10) Pub. No.: US 2008/0201433 A1
(43) Pub. Date: Aug. 21, 2008

(54) METRIC-BASED ELECTRONIC MAIL SYSTEM

(76) Inventor: Stephen McDonald, Somerville, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 11/675,187

(22) Filed: Feb. 15, 2007

(51) Int. Cl. G06F 15/16

(52) U.S. Cl. 709/206

(57) ABSTRACT

Described are an electronic communication system and method for routing an electronic mail (email) message. The system includes a database and an email server that receives an email message from a client system over a network. The email message has sender-specified delivery criterion associated therewith. The email server communicates with the database to identify dynamically one or more email addresses of email users based on the delivery criterion associated with the email message. The email server forwards the email message to each dynamically identified email address.

### FIELD OF THE INVENTION

The invention relates generally to electronic communication systems. More particularly, the invention relates to a metric-based electronic mail (email) system and method that dynamically identifies recipients of email messages based on criteria established and associated with the email messages by their senders.

### BACKGROUND

Electronic mail has revolutionized business and personal communications. Today, almost anyone connected to the Internet is able to compose and send an email message to one or more email users practically anywhere in the world, provided the email sender knows and enters their email addresses into the header of the email message. An email sender can also send an email message to multiple individuals concurrently using an electronic mailing list (also called a distribution list). A mailing list is generally a collection of names (and associated email addresses) that provides a convenient technique for send messages to a group of people. Using an email application program, email users can generate and maintain their own electronic mailing lists, adding to and deleting email addresses from each list as deemed fit. Notably, when a sender sends forth an email message addressed to a mailing list, the email addresses of the target recipients are already determined (i.e., “known” by the email program, if not by the sender) at that time.

Email servers can also maintain electronic mailing lists comprised of the email addresses of “subscribers.” To send an email message to subscribers in a mailing list, a sender typically addresses the message to an email “reflector address” of the email server. When the email server receives an email message addressed to the reflector address, the server distributes the message to the email messages currently on the associated mailing list. Again, although the particular subscribers on a given mailing list can change from time to time, when the email server receives an email message for distribution to the subscribers of a given mailing list, the target recipients of the email message are already “known” at that time, i.e., being determined by the email addresses currently on the list.

There are instances, however, when an email user would like to communicate by email with a certain group of people, but does not know their email addresses or any particular mailing list to which they belong. For example, an individual moves into a new town and would like to speak with neighbors about the local school system. Not knowing their email addresses, the individual is unable to communicate with the neighbors through email.

### SUMMARY

In one aspect, the invention features a method for routing an electronic mail (email) message. An email message is received by a server system over a network. The email message has at least one sender-specified delivery filter associated therewith. The server system dynamically identifies one or more email addresses of email users who satisfy each sender-specified delivery filter associated with the email message.

In another aspect, the invention features an electronic communication system, comprising a database and an email server receiving an email message from a client system over a network. The email message has sender-specified delivery criterion associated therewith. The email server communicates with the database to identify dynamically one or more email addresses of email users based on the delivery criterion associated with the email message.

In still another aspect, the invention features a computer program product comprising a computer-useable medium having a computer-readable program code embodied in said medium for generating electronic mail messages. The computer readable program code in said computer program product comprises computer-readable program code for causing the computer to generate an email message, and computer-readable program code for causing the computer to enable a sender of the email message to select and associate a delivery filter with the email message. The selected delivery filter corresponds to a domain to which users may belong and causes an email server that receives the email message to restrict dynamically identified target recipients of the email message to those users belonging to the domain.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram representation of a metric-based email system constructed in accordance with the invention.

FIG. 2 is a flow diagram of an embodiment of a process by which a user of a client computing system participates in the metric-based email system of the invention.

FIG. 3 is a flow diagram of an embodiment of a process by which a server system forwards email messages in accordance with the invention.

FIG. 4 is a flow diagram of an embodiment of a process by which a server system identifies target recipients of email messages in accordance with the invention.

### DETAILED DESCRIPTION

Metric-based electronic mail (email) systems constructed in accordance with the invention enable users to send email messages to others without necessarily having a priori knowledge of the identity of those other people or of their email addresses. In brief overview, an email sender composes an email message and then selects one or more delivery filters that become part of the email message. Each delivery filter operates as criterion that determines who the target recipients of the email message will be. An email server uses each delivery filter associated with the email message to identify the target recipients. Based on the particular delivery filter, the email server may compute a metric (e.g., numerical, Boolean) used in identifying target recipients. The identification of the recipients occurs dynamically, when the email server receives and determines that the email message has one or more associated delivery filters.

To identify such recipients, the email server communicates with a database that holds the email addresses of registered users. In addition to their email addresses, registered users also provide the identity of one or more domains for which they wish to be registered and any supplemental information required by their selected domains. The database operates to associate the selected domains of registered users with their email addresses. Each delivery filter that is part of the email message corresponds to a domain to which users may belong. Based on a given delivery filter, the email server identifies the corresponding domain and queries the database to obtain the email addresses of those users belonging to that domain. Any supplemental information accompanying the delivery filter serves as additional criterion for the database to use when searching for target email addresses. The email server then forwards the email message to those dynamically identified email addresses.

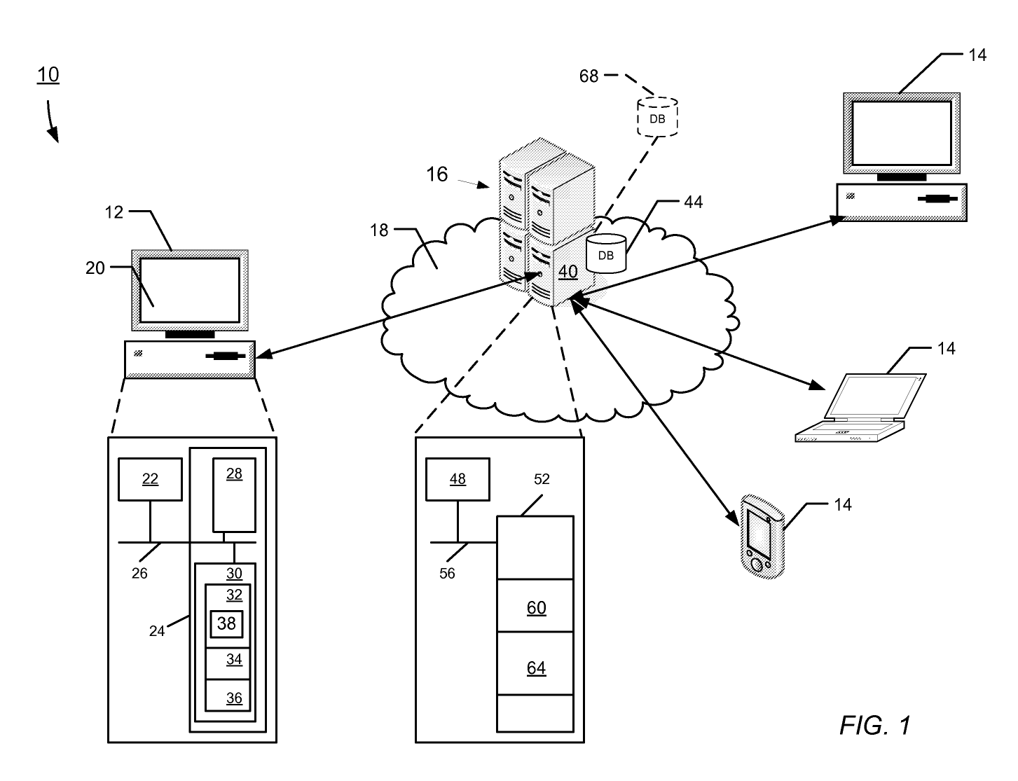

FIG. 1 shows an embodiment of a metric-based email system 10 configured in accordance with the present invention. The email system 10 includes a client computing system 12 in communication with one or more other computing systems 14 through a server system 16 over a network 18. Exemplary implementations of the computing systems 12, 14 include, but are not limited to, personal computers (PC), Macintosh computers, workstations, laptop computers, kiosks, hand-held devices, such as a personal digital assistant (PDA) and iPhones™, cellular phones, navigation and global positioning systems, and network terminals.

The client computing system 12 includes a display screen 20 and a processor 22 in communication with system memory 24 over a signal bus 26. The system memory 24 includes non-volatile computer storage media, such as read-only memory (ROM) 28, and volatile computer storage media, such as random-access memory (RAM) 30. Typically stored in the ROM 28 is a basic input/output system (BIOS), which contains program code for controlling basic operations of the computing system 12 including start-up of the computing device and initialization of hardware. Temporarily or permanently resident in the RAM 30 are program code and data. Program code includes, but is not limited to, application programs 32, program modules 34 (e.g., browser plug-ins), and an operating system 36 (e.g., WINDOWS 95, WINDOWS 98, WINDOWS NT 4.0, WINDOWS XP, PALM OS, Macintosh, JAVA, LINUX, UNIX, and WINDOWS CE for windows-based terminals).

Application programs 32 include browser software, e.g., MICROSOFT INTERNET EXPLORER™, Safari™, and Mozilla Firefox™, and, optionally office applications, such as MICROSOFT WORD™. One application program 32 is an email client program 38 by which users of the client computing system 12 can read, compose, and send email messages over the network 18. The email client program 38 can be any proprietary email client program or a version of any commercially available email client program, such as Microsoft OUTLOOK™ and Mozilla Thunderbird™, modified to support metric-based email, as described herein. In addition, the email client program 38 may be configured to support HTML (Hypertext Markup Language) email.

Instead of using the email client program 38, users of the email system 10 can run, through their Web browsers, a Web application to access their email over the network 18. The Web application can be any proprietary program or a version of any commercially available Web application, such as Google Gmail™, Yahoo! Mail™, and Hotmail™, modified to support metric-based email.

The user interface provided by the email client program 38 (or by the Web application) presents email messages with an email header comprised of a “To” field and a subject field, and an email body. The user interface also includes an “Add Filter” function, accessible, e.g., through a pull-down menu. As described further below, before sending an email message, a user can select one or more delivery filters, as many as are available and desired, to be used in identifying target recipients of the email message. In general, each delivery filter corresponds to a domain, which may also be thought of as fields, subjects, topics, areas of interest, groups, categories, clubs, memberships, teams, spaces, and the like, to which email users may belong. Exceptions to this generalization are those filters that can apply to all domains. One such example is a filter by which an email sender can specify a maximum limit to the number of target email addresses to which the sender's email is distributed. Depending on the type of delivery filter selected, the email sender may need to enter supplemental information to complete the specification of the selected delivery filter. The user interface also presents functionality for creating, deleting, and editing delivery filters.

Typically, the signal bus 26 connects the processor 22 to various other components of the client computing system 12 including, for example, a user-input interface, a memory interface, a peripheral interface, a video interface, a local network interface, and a wide-area network interface (not shown). Through a network interface, the client computing system 12 communicates with the server system 16 over the network 18. Embodiments of the network 18 include, but are not limited to, local-area networks (LAN), metro-area networks (MAN), and wide-area networks (WAN), such as the Internet or World Wide Web. The client computing system 12 can connect to the server system 16 over the network 18 through one of a variety of connections, such as standard telephone lines, digital subscriber line (DSL), asynchronous DSL, LAN or WAN links (e.g., T1, T3), broadband connections (Frame Relay, ATM), and wireless connections (e.g., 802.11(a), 802.11(b), 802.11(g)).

The server system 16 includes one or more server computers comprising an email server 40 and a database 44 for storing information, such as usernames, passwords, associated email addresses, and various domains used in the routing of email messages in accordance with the principles of the invention. The email client program 38 (or Web application) communicates with the email server 40 over the network 18 to receive and send email messages. The server system 16 can also include a Web server for hosting a web site to which the user of the browser of the client computing system 12 navigates for purposes of registering with the metric-based email system 10, as described herein.

In one embodiment, the email server 40 includes a processor 48 in communication with memory 52 over a signal bus 56. The memory 52 includes non-volatile computer storage media (e.g., ROM) and volatile computer storage media (e.g., RAM). Resident within the memory 52 are program code and data. Program code includes, but is not limited to, an email server program 60 configured in accordance with the present invention to perform the various server-side metric-based email functionality described herein. The email server program 60 and, other application programs on the email server 40, run on an operating system 64 (e.g., WINDOWS 95, WINDOWS 98, WINDOWS NT 4.0, WINDOWS XP, PALM OS, Macintosh, Java, LINUX, UNIX, and WINDOWS CE for windows-based terminals).

The database 44 stores associations between domains and the email addresses of email users who are members of the domains. Domains are limitless in type and number. Some exemplary categories of domains (with an example of a domain in that category) include, but are not limited to, residents of a particular town (e.g., Cambridge, Mass.), members of a particular profession (e.g., dentists), individuals with a particular hobby (e.g., skiing), employees with a particular title (e.g., Vice President), people living within a particular geographical radius of a given reference point (e.g., the geographical location of the email sender). The database 44 can be implemented as a relational database (e.g., SQL), one or more spreadsheets, one or more tables, or combinations thereof.

To participate in the metric-based email system 10, at least to receive email messages in accordance herewith, users generally register with the server system 16. (In some instances, users can send and receive metric-based email without registering, as described below). Upon registering, an email user can become members of one or more domains by default, by choice, or both, providing certain information germane to the domain or domains to which they will belong. Registration can be achieved through direct browser-based navigation to a web site configured for administering the metric-based email system 10. Alternatively, participants may register through the email client program 38 (or through a Web application) configured to allow participants to view, add, delete, join, and leave domains.

The creator of a particular domain, in general, determines the type of information considered pertinent for users to supply when registering with that domain. The metric-based email system can initialize with a base set of domains. Participants of the email system 10 can then add new domains to this base set. When submitting a new domain to the metric-based email system, a domain creator specifies the type of domain and the type of supplemental information to register for the domain so that the email server 40 is able to compute a metric for the domain. For example, the domain creator can create a “Bowlers” domain and require users to indicate their average score when registering for the domain. The domain creator can also specify one or more keywords and a domain description so that participants of the email system 10 can find and learn about existing domains. For the “Bowlers” example, the domain creator can submit “candlepin,” “bowling,” and “bowlers” as keywords, and “Club for candlepin bowling in Central Massachusetts” as a description.

The following are other examples, by no means exhaustive, of domains and the type of information that a user may be prompted to supply to belong to that domain. To belong to a “Geographical” domain, an email user may need to submit a zipcode, GPS coordinates (longitude and latitude), or both. For a “Joggers” domain, an email user can submit a numerical value representing the average number of miles run per week. For a “Dog Owners” domain, an email user can submit a Boolean value indicative of YES or NO. A “Knitters” domain can request an email user to specify a numerical value representing the number of hours per week engaged in the task of knitting. For email users belonging to a “Skiing” domain, the email system 10 may request that the email user provide a level of expertise by indicating EXPERT, NOVICE, or BEGINNER. Other information provided upon registering for a domain includes the email address or addresses of the registering email user. Registration may also require submission of certain information, such as a username, a password, an address of residence, a business address, or a post office address.

Domains may be public, private, or semi-private. Public domains are available to any who wish to register in that domain. Anyone registering with the email system 10 can be placed, by default, into a public domain. Private domains are generally created and controlled by one email user (i.e., the domain creator). The domain creator determines which email addresses are associated with a private domain, and may be the only email user who knows of the existence of the private domain and the email addresses associated with it. No one, other than the domain creator (or someone who has been granted privileges), is able to register for or modify the domain or its members.

For example, a domain creator may create a “Friends” domain. The only email addresses associated with the Friends domain are those that the domain creator specifically adds to the domain. (This is an example of an instance where a user can become are target recipient of email through the metric-based email system 10, without having personally registered with the server system 16—this is because the domain creator has, in effect, “registered” the email address of that email user by adding the user's email address to the private domain).

Semi-public domains permit any member of the domain to see all other members of the domain, but restrict others from freely joining. One or more email users, e.g., certain members of the domain, have the role of controlling domain membership. Semi-public domains function similarly to a club or a mailing list.

In one embodiment, the email system 10 includes a Geographical domain, and an email user becomes a member of the Geographical domain automatically upon registering. As a member of this domain, the email user is required to provide a zipcode, GPS coordinates, or both. The email server 40 uses this supplied information to compute a geographical distance between potential target recipients and a reference location (e.g., the GPS coordinates of associated with the email sender). The geographical distance comes into operation when the email server filters email addresses based on distance, as described below.

In another embodiment, the email server 40 is in communication with a public or private third-party database 68. For example, corporations often maintain databases containing employee information (often held privately). As another example, some organizations offer publicly accessible databases (e.g., lawyer lookups). When a sender sends an email message, the sender can specify the database 68, e.g., through a drop-down menu item, as the data source from which the email server obtains email addresses of target recipients. The metric-based email system 10 can use this database 68 instead of or in conjunction with the database 44.

In the previously described embodiment, each database 44, 68 is accessible through the email server 40. In other embodiments, each database 44, 68 can reside on a different server system (i.e., managed by separate, independent entities). For example, an email sender can be registered with multiple metric-based email systems, each hosting its own separate database (e.g., one hosted by a professional society, another maintained by the email sender's college, and yet another run by fans of the email sender's favorite author). When the email sender then sends an email message, the sender can specify the server system (in contrast to specifying a particular database, as described previously) with which the email application communicates to acquire the email addresses of target recipients.

As previously noted, email senders may not need to register with the server system 16 to participate in the metric-based email system 10, because some domains may not require any information about the email sender in order to identify target recipients of the email message. For example, an email sender may be seeking a dentist within a certain town and may add a “Dentists” filter to an email message, specifying the zipcode of the town. The email server 40 can identify target recipients as those email users who belong to a “Dentists” domain and who have the same zipcode as the zipcode specified with the “Dentists” filter. The email server 40 then sends the email message to the identified dentists. Consequently, the email sender is able to send an email to one or more dentists without ever having to register with email system 10

Previously, the invention has been described with reference to embodiments having an email server that identifies target email addresses satisfying certain filter criterion and then sends the email to those email addresses. In another embodiment, the email application (i.e., email client program or Web application) communicates with a Web service, also known as an application service, hosted by a Web server (e.g., of the service system 16). In this embodiment, the email sender selects one or more filters for an email and sends these filters (with or without the email, i.e., as its own separate message) to the Web service. Based on each filter and on the particular operation(s) to be applied (i.e., intersection or union), the Web server returns those email addresses satisfying the filter criterion to the sender. The sender can then directly enter one or more of these email addresses into the header of an email and send the email to a standard email server for subsequent delivery. Structuring a metric-based email system as a Web service may be simpler and less costly for organizations with existing databases (e.g., schools, corporations, professional organizations) to implement than having to provide and support an email server and a duplicate database.

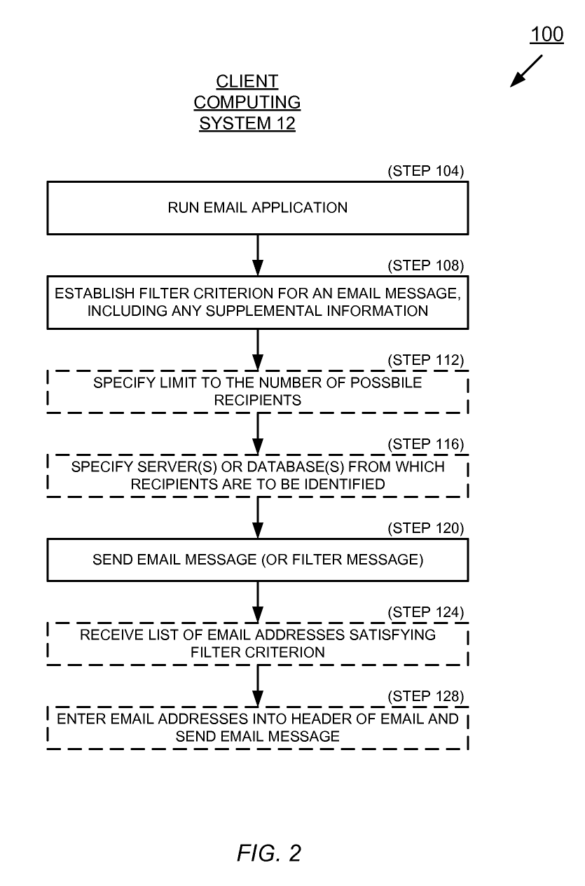

FIG. 2 shows an exemplary embodiment of a process 100 by which a user of the client computing system 12 generates and sends an email message to recipients unknown in accordance with the invention. At step 104, the user runs an email application (i.e., email client or Web application) and generates an email message. This email message can be a new message or a reply to or forwarding of an existing message. In the generation of the email message, the user can leave the “To:” field of the email header empty (i.e., the user can, but need not enter any target email addresses in the email header).

At step 108, the user applies one or more delivery filters to the email message to determine to whom the email message may be delivered. The user may not know who the particular recipients will be, but knows that each recipient will satisfy each selected delivery filter. In one embodiment, the user opens a drop-down menu from the toolbar. The drop-down menu gives the user an option to view and select one or more delivery filters to be added to the email. In general, delivery filters correspond to domains, that is, the type of each selected delivery filter determines a domain from which target recipients, if any, are selected. For example, if the selected delivery filter is “Dog Owners”, the potential target recipients of the email message are restricted to members belonging to the “Dog Owners” domain. If the sender selects more than one filter, the sender may need to provide the type of operation to be performed on the filters (i.e., union or intersection). In one exemplary implementation, an intersection operation is applied by default unless the sender selects an union operation.

The type of delivery filter selected by the email sender can require entry of supplemental information. For example, if the user chooses the “Geographical” filter described above, the email application may prompt the user to supply a zipcode. In another embodiment, the “Geographical” filter can require the user to provide GPS coordinates and to specify a number of miles for use in computing a radius of this geographical distance originating from these GPS coordinates. The coordinates may be that of any location of the sender's choosing or of the sender's client computing system 12. In one embodiment, the client computing system 12 is in communication with or equipped with a GPS system for supplying such coordinates, manually or automatically, to the email application.

Optionally, the email sender can also specify (step 112) a limit to the number of possible recipients. By specifying a limit to the number of people who see the email message, the email sender can thereby provide a bound to the number of possible responses. The option to specify a limit can appear as a separate, selectable filter. In addition, the email sender can optionally specify (step 116) the database or databases (or server(s)) from which the target email recipients are to be selected. The option to specify a database (or server) can appear as a selectable item in the drop-down menu. After selecting each desired filter and supplying the appropriate supplemental information, the email sender sends (step 120) the email message. The supplied delivery filter information and supplemental information are embedded in the transmitted email.

If the metric-based email system is implemented as a Web service, at step 120 the email application can send a “filter message,” which may or may not be the actual email message intended for eventual distribution by the email sender. This filter message includes the filter criterion specified by the email sender (i.e., the set of selected filters, specified limit, identified server or database). In response to this filter message, the email application receives (step 124), from a Web server hosting the Web service, a list of those email addresses that satisfy the filter criterion. The email sender can then enter (step 128) one of more of the acquired email addresses into the header of the email message and send the email message. Alternatively, the email application can automatically fill the header of the email message with the acquired email addresses, with the email sender having the opportunity to edit these defaults.

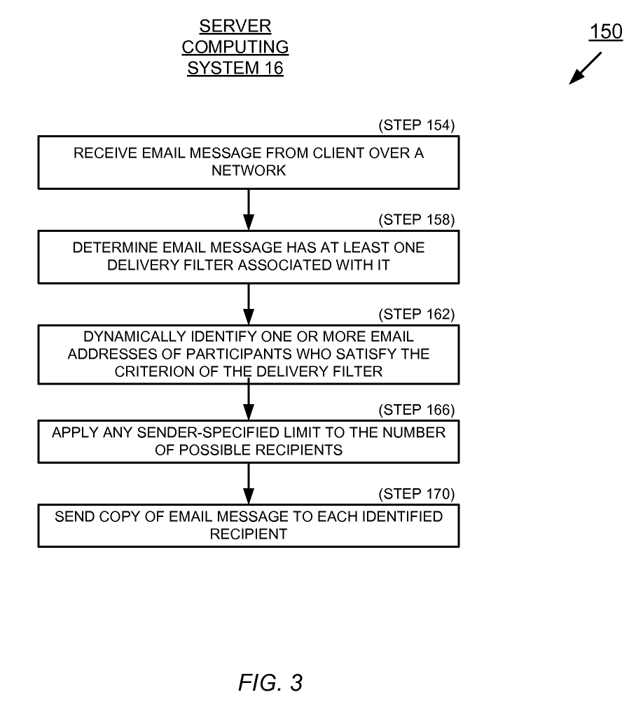

FIG. 3 shows an exemplary embodiment of a process 150 by which the server system 16 forwards email messages in accordance with the invention. In this example, the metric-based email system is implemented with an email server that identifies target recipients for an email based on delivery filter criterion and forwards the email to such recipients. At step 154, the email server 40 receives an email message from the client computing system 12 over the network 18. The email server 40 determines (step 158) that the email message has at least one delivery filter embedded therein. Based on the type of delivery filter, and on any supplemental information supplied by the email sender, the email server 40 queries the database 44, a sender-specified database 68, or both. Through this querying, the email server 40 dynamically identifies (step 162) one or more email addresses of users that satisfy the criteria set forth by the delivery filters and supplemental information attached to the email message. If the email sender has specified a limit to the number of recipients, the email server 40 applies (step 166) this limit to restrict the number of email addresses returned as a result of the database querying. At step 170, the email server 40 forwards a copy of the email message to each identified email address. In one embodiment, the email server 40 may tell the email sender (e.g., through a type of receipt notification mechanism) who the identified target recipients are. In another embodiment, the identified target recipients remain anonymous to the email sender and to each of the other recipients.

Before forwarding a copy of the email message to each identified target recipient, the email server 40 may insert the email address of that recipient into the “To:” field of the email header, and the email addresses of the other recipients into the “cc:” field. Each recipient of the email message can subsequently reply to the email sender, and, optionally, to each other recipient, provided the email addresses of such other recipients are disclosed in the “cc:” field.

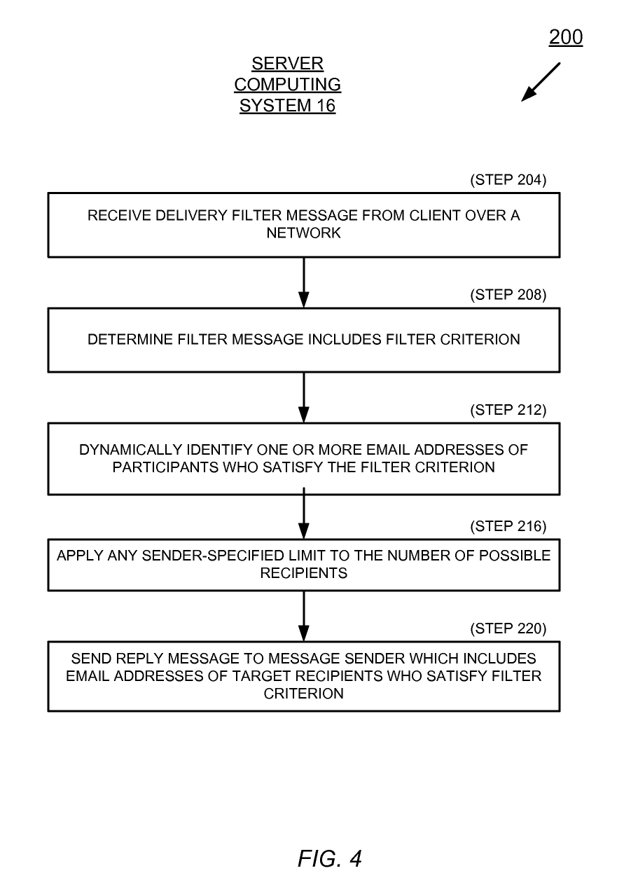

FIG. 4 shows an exemplary embodiment of a process 200 by which the server system 16 identifies target recipients for email messages in accordance with the invention. In this example, the metric-based email system is implemented as a Web service hosted by a Web server of the server system 16. At step 204, the Web server receives a filter message from the client computing system 12 over the network 18. The Web server determines (step 208) that the filter message includes filter criterion. Based on the filter criterion, the Web server queries a database (potentially selected by the message sender). Through this querying, the Web server dynamically identifies (step 212) one or more email addresses of users that satisfy the filter criterion. If the message sender has specified a limit to the number of recipients, the Web server applies (step 216) this limit to restrict the number of email addresses returned as a result of the database querying. At step 220, the Web server sends a reply message to the message sender. The reply message includes the email addresses of each target recipient found to satisfy the filter criterion.

The following examples illustrate exemplary operations of the metric-based email system. Consider that the email server 40 determines that a “Geographical” filter is attached to the email message and that the supplemental information includes a zipcode. In this instance, the email server 40 identifies email addresses of users who have supplied the same zipcode as part of their registration information. Consider further that the sender of the email address also specifies a limit on the number of potential target recipients. The email server 40 accordingly would select at most that many email addresses (using predetermined criteria, e.g., alphabetic order of the email addresses or of the names of the target recipients).

As another example, consider a Geographical filter that uses physical distance (instead of zipcode) to identify email addresses of potential target recipients. For instance, the email sender may be trying to report a lost dog to others in the neighborhood and believes that the email may be relevant to those neighbors within five miles of the sender's residence. In this example, the email sender specifies a numerical value (i.e., five) to be used by the email server as a geographical distance. The email server 40 then computes a five-mail radius from the residence of the email sender (e.g., using the GPS coordinates supplied by the sender, whether supplied upon registering or upon adding the filter to the email) and searches the database for email addresses of users who supplied coordinates that fall within five miles of the sender's coordinates. If, instead, the email sender is looking to borrow a book or a piece of gardening equipment, the email sender can specify a lesser distance (e.g., 1 mile) and limit the number of recipients to 10. In this instance, the email server 40 can limit the number of target recipients based on their proximity to the email sender (i.e., select the ten who are geographically the closest to the sender).

As another example, an email sender is running a ski resort and wants to advertise a ski-weekend package. Before sending an email message, the email sender selects and adds a “Skiers” filter to the email. Upon receiving the email, the email server queries the database for those users who belong to the “Skiers” domain and forwards the email to those users.

The email sender can select, and the email server can use, multiple filters to identify target email recipients. For example, consider in the previous example that the email sender wants to advertise the ski-weekend package specifically to skiers who live within fifty miles of the resort. In this instance, the email sender specifies a “Skiers” filter and a “Geographical” filter. With the geographical filter, the email sender supplies a metric of 50 miles. The email server then searches for target recipients that satisfy the Skiers filter and the Geographical filter with a 50-mile limitation (i.e., an intersection of both the Skiers domain and the 50-mile-filtered Geographical domain).

As another example, an optometrist opens an eyeglass business in an unfamiliar town. So that the eyeglass business may receive email messages from individuals seeking eyeglass services, the optometrist registers with the metric-based email system in an “Optometrist” domain (first creating the domain if it does not already exist). In effect, the optometrist will be available to receive emails directed to the Optometrist domain (i.e., using an Optometrist filter). The optometrist can also announce the opening of the new eyeglass business by composing an email message, applying a “Geographical” filter specifying the zipcode of the hometown (or a geographical distance), and sending forth the email message. The announcement then gets distributed to each user having registered with the same zipcode (or within the specified geographical distance).

As another example, the email sender moves into a new neighborhood and seeks price quotes from all house painters within or near his or her new hometown. The email sender selects and adds a “Professional Painters” filter and a “Geographical” filter to the email, specifying one or more zipcodes. The email server finds those email users belonging to the “Professional Painters” domain and filters out those who are not within one of the specified zipcodes (i.e., selects those who are within the zipcodes).

Instead of returning the intersection of multiple domains, as illustrated by the previous examples, the email server can return the union of those domains. For example, consider an email sender who wants to find tickets for any sports event held at the Boston Garden. In this instance, the email sender can specify a “Boston Bruins” filter and a “Boston Celtics” filter. Through the user interface, the email sender also specifies that a union operation is to be applied to these filters. The email server (or Web service) then searches for target email addresses in domains that satisfy either of the Boston Bruins or Boston Celtics filters. In one embodiment, the email server (or Web service) can detect and remove duplicate target email addresses (i.e., a member belonging to more than one domain).

While many of the previous examples illustrate the benefits of metric-based email for individuals, organizational entities of various types can also use metric-based email to communicate with others who are likely to share an interest in the products or services offered by the organization. For example, consider a national amateur astronomy organization that runs a metric-based email Web service and an email sender who wants to announce the installation of his new large telescope to high school teachers within 20 miles of its installation. Through a Web application interface, for example, this email sender can select a server system identified with the amateur astronomy association, a “High School Teachers” filter, and a “Geographical” filter. For the geographical filter, the email sender specifies a metric of 20 miles. The email sender sends these filters to the server system of the amateur astronomy association, which searches its own database(s) for email addresses of members who are in the High School Teachers domain and satisfy the 20-mile requirement. The server system returns the qualifying email addresses to the email sender. The email sender can then address the email to any one or all of the email addresses returned by the server system. Similarly, a science museum could advertise a lecture series using the same filter criterion as the previous email sender to identify potential advertisement recipients.

Program code (or software) of the present invention may be embodied as computer-executable instructions on or in one or more articles of manufacture, or in or on computer-readable medium. A computer, computing system, or computer system, as used herein, is any programmable machine or device that inputs, processes, and outputs instructions, commands, or data. In general, any standard or proprietary, programming or interpretive language can be used to produce the computer-executable instructions. Examples of such languages include C, C++, Pascal, Java, BASIC, HTML, JAVASCRIPT, PHP, Perl, Ruby, Visual Basic, and Visual C++.

Examples of articles of manufacture and computer-readable medium in which the computer-executable instructions may be embodied include, but are not limited to, a floppy disk, a hard-disk drive, a CD-ROM, a DVD-ROM, a flash memory card, a USB flash drive, an non-volatile RAM (NVRAM or NOVRAM), a FLASH PROM, an EEPROM, an EPROM, a PROM, a RAM, a ROM, a magnetic storage media, optical storage media, or any combination thereof. Computer-readable medium also includes electrical, optical, acoustical, or other form of propagated signals (e.g., carrier waves, infrared signals, digital signals). The computer-executable instructions may be stored as, e.g., source code, object code, interpretive code, executable code, or combinations thereof. Further, although described predominantly as software, embodiments of the described invention may be implemented in hardware, software, or a combination thereof.

While the invention has been shown and described with reference to specific preferred embodiments, it should be understood by those skilled in the art that various changes in form and detail may be made therein without departing from the spirit and scope of the invention as defined by the following claims. For example, in an alternative embodiment, the client computing system 12 can be any terminal (windows or non-windows based), or thin-client device operating according to a server-based computing model. In a server-based computing model, the execution of application programs occurs entirely on an application server (not shown), and the user interface, keystrokes, and mouse movements are transmitted over the network 18 to the client computing system 12. The user interface can be text driven (e.g., DOS) or graphically driven (e.g., Windows).

What is claimed is:

1. A method for routing an electronic mail (email) message, comprising:
receiving, by a server system, an email message over a network, the email message having at least one sender-specified delivery filter associated therewith; and
dynamically identifying, by the server system, one or more email addresses of potential recipients who satisfy at least one sender-specified delivery filter associated with the email message.

2. The method of claim 1, wherein at least one delivery filter includes a sender-specified value representing a geographical distance, and wherein the step of dynamically identifying one or more email addresses includes identifying the email address of each potential email recipient who has registered a physical mailing address within the specified geographical distance of a reference point associated with the sender of the email message.

3. The method of claim 1, wherein at least one delivery filter includes a sender-specified value corresponding to a maximum number of potential recipients of the email message, and wherein the step of dynamically identifying one or more email addresses includes the step of limiting a number of identified email addresses to the maximum number.

4. The method of claim 3, wherein the step of limiting the number of potential recipients selects email addresses based on a geographical proximity of each potential recipient to a reference point designated by the sender of the email message.

5. The method of claim 1, wherein at least one delivery filter includes a sender-specified value corresponding to a postal zip code, and wherein the step of dynamically identifying one or more email addresses includes identifying each potential recipient who has a postal mailing address within the specified postal zip code.

6. The method of claim 1, wherein the email message, upon receipt by the server system, lacks a specified target email address.

7. The method of claim 1, wherein at least one delivery filter corresponds to a domain, and the step of dynamically identifying email addresses includes identifying each email address associated with an email user who has registered in the domain.

8. The method of claim 1, further comprising the steps of registering an email address of an email user and associating this email address with domain-related information specified by the email user to be used by the server system in determining whether the email message is to be forwarded to that email user.

9. An electronic communication system, comprising:
a database; and
a server system receiving an email message from a client system over a network, the email message having sender-determined delivery criterion associated therewith, the server system communicating with the database to identify dynamically one or more email addresses of email users based on the delivery criterion associated with the email message.

10. The system of claim 9, wherein the delivery criterion includes a value specified by a sender of the email message.

11. The system of claim 10, wherein the value specifies a geographical distance, and wherein the server system dynamically identifies each target email recipient with a physical mailing address within the specified geographical distance of a reference point associated with the sender of the email message.

12. The system of claim 10, wherein the value corresponds to a maximum number of target recipients of the email message, and wherein the server system limits a number of identified email addresses to the maximum number based on proximity of each target recipient to the sender of the email message.

13. The system of claim 10, wherein the value specified by the sender of the email message corresponds to a postal zipcode, and wherein the server system dynamically identifies each target recipient who has a mailing address within the specified postal zipcode.

14. The system of claim 9, wherein the email message, upon receipt by the server system, lacks a specified target email address.

15. The system of claim 9, further comprising a registration system by which email users register email addresses with domains.

16. The system of claim 9, wherein the delivery criterion specifies a domain, and wherein the server system queries the database to identify each email address associated with an email user who belongs to the domain.

17. A computer program product comprising:
a computer-useable medium having a computer-readable program code embodied in said medium for generating electronic mail messages, the computer readable program code in said computer program product comprising:
computer-readable program code for causing the computer to generate an email message; and
computer-readable program code for causing the computer to enable a sender of the email message to select and associate a delivery filter with the email message, the selected delivery filter corresponding to a domain to which users may belong and causing an email server that receives the email message to restrict dynamically identified target recipients of the email message to those users belonging to the domain.

18. The computer program product of claim 17, wherein the selected delivery filter includes a sender-specified metric by which the email server receiving the email message computes a value used to dynamically identify target recipients of the email message.

19. The computer program product of claim 17, further comprising computer-readable program code for causing the computer to associate a limit to a number of target recipients of the email message.

20. The computer program product of claim 17, further comprising computer-readable program code for causing the computer to display existing domains to which users may belong.
